(19) United States
(12) Patent Application Publication
(10) Pub. No.: US 2013/0263090 A1
(43) Pub. Date: Oct. 3, 2013

(54) SYSTEM AND METHOD FOR AUTOMATED TESTING

(71) Applicants: Jason Polk, San Diego, CA (US); David Avram, San Diego, CA (US); Sean Campbell, San Diego, CA (US)

(72) Inventors: Jason Polk, San Diego, CA (US); David Avram, San Diego, CA (US); Sean Campbell, San Diego, CA (US)

(73) Assignee: SONY ONLINE ENTERTAINMENT LLC, San Diego, CA (US)

(21) Appl. No.: 13/434,929

(22) Filed: Mar. 30, 2012

(51) Int. Cl. G06F 11/36

(52) U.S. Cl. 717/124

(57) ABSTRACT

Provided is an automation suite designed to automate game and web testing. The system may be driven by a scripting engine that makes use of OCR and object recognition and rapid image analysis to perform its automation tasks. The system may perform its tasks individually or collectively, potentially spawning numerous clients capable of communication and coordinating with one another.

### BACKGROUND

Modern games, particularly those in the MMO space, are becoming increasingly complex. Most games in this category contain hundreds of systems and have development teams that number in the hundreds. A deluge of content is generated for an MMO each day, and testing teams are expected to test all of it to ensure accuracy and completeness.

A typical testing team can easily number 10 to 30 members depending on the scope of the game they support. Often, these testers are expected to perform a manual testing “regression”, or what could be considered a “walk-through” of the entire game to ensure that nothing has broken between builds. This process is often time-consuming and inefficient as the testers are effectively looking for issues that they have already found in the past, or are simply verifying that expected functionality exists. In some cases, testers have to work together to verify functionality. This can also be very time-consuming, as the testers have to wait on one another to reach a particular state before continuing.

Some efforts have been made to remedy such deficiencies, but such efforts generally only allow manual testers to save keystrokes by use of macros. In addition, many such prior systems only test on internal game memory, which can be disadvantageous. Furthermore, such systems often require knowledge of the state the system is in, which can also be disadvantageous.

### SUMMARY

Systems and methods according to the principles described here preclude the need for testers to perform certain manual regression passes by automatically performing and verifying the results of tests. The systems and methods according to certain implementations perform these tests, also known as tasks, by approaching the task in the same fashion as a live tester: by analyzing the screen, e.g., a frame buffer, and verifying its contents. Tests can be made dependent on the results of prior tasks. In this manner, testing can be performed in a fraction of the time required by a live tester. The systems and methods may take advantage of any or all of the advances in computing over the last several years, including multiple core CPUs, GPU's, and the like.

Systems and methods according to the principles disclosed here may include a number of systems, including: a scripting engine, a distributed execution framework, a full-featured automation IDE, web-based management and reporting, integration with third-party products, and rapid integration with games or other applications for testing.

The systems and methods provide an automation suite designed to automate game and web testing. The system may be driven by a scripting engine that makes use of image recognition and rapid image analysis to perform its automation tasks. Tasks may be performed individually or collectively, potentially spawning hundreds of clients capable of communication and coordination with one another.

In one aspect, the invention is directed towards a method of testing at least a portion of an application, an instantiation of the application running on each of a plurality of computing devices, including: displaying a list of potential tests, each test associated with a test script; receiving a selection of a test from the list; assigning the selected test to one of the plurality of computing devices; running the test script on one of the plurality within the instantiation of the application; and analyzing an output of the one of the plurality to determine a result of the run test script.

Implementations of the invention may include one or more of the following. The assigning the selected test may include receiving an input indicating the one of the plurality on which to run the test script. The analyzing an output may include analyzing a frame buffer, analyzing a memory state, or examining a network packet. The assigning the selected test may include determining a one of the plurality on which to run the test script, the determining including determining a one of the plurality which is capable of running the test script and which is currently not running another test script.

The receiving and assigning may include receiving a selection of a first test and assigning the selected first test to a first one of the plurality, and further may include receiving a selection of the second test from the list, and assigning the selected second test to the one of the plurality or to another of the plurality. The receiving and assigning may also include receiving a selection of a first test and assigning the selected first test to a first thread on the one of the plurality, and further may include receiving a selection of the second test from the list, and assigning the selected second test to a second thread on the one of the plurality. The method may further include analyzing a log to determine at least one operating parameter pertaining to the result. The result may be null result, an error message, or the like. The method may further include displaying an indication of the result. The test script may cause a step of optical character recognition of a displayed text within the frame buffer. The test script may also cause a step of object recognition of an object within the frame buffer. The test script may also cause a step of simulating input from a mouse, keyboard, or game pad. The method may further include generating a test script upon receipt of an error notification from a software development tracking application. The method may further include displaying a combined result corresponding to the analyzed output and the analyzed log. The method may further include selecting another test from the list, the another test selected based on the result, assigning the another test to the one of the plurality, running a test script associated with the another test on the one of the plurality within the instantiation of the application, and analyzing an output of the one of the plurality to determine a result of the run test script associated with the another test. The test and the another test simulates actions of a bot or of a plurality of such bots. The simulated bots may be configured to accomplish a singular group goal. The test may be associated with a job, and the job may include a plurality of tests.

In another aspect, the invention is directed towards a non-transitory computer-readable medium, comprising instructions for causing a computing device to perform the above method.

Advantages of the invention may include one or more of the following. The systems and methods may be particularly efficient at testing or verifying expected functionality or known bugs, thus allowing manual testers to be more efficient by allowing them to focus on finding new bugs or other issues with applications, such as video games. A full regression of a game may take several hundred hours to complete, or even more. By allowing certain tests to be performed automatically, these manual testers can use such time to improve games and their contents. Other advantages will be apparent to one of ordinary skill in the art given this teaching, including the figures and claims.

### BRIEF DESCRIPTION OF THE DRAWINGS

FIG. 1 illustrates a number of modules which may be employed in systems and methods according to the principles described here.

FIG. 2 illustrates modules within the scripting engine module of FIG. 1.

FIG. 3 illustrates modules within the distributed execution framework module of FIG. 1.

FIG. 4(A)-(C) illustrates modules within the automation IDE module of FIG. 1, and

FIG. 4D illustrates an exemplary user interface of the IDE.

FIG. 5 illustrates modules within the management/reporting module of FIG. 1.

FIG. 6 illustrates modules within the third-party integration module of FIG. 1.

FIG. 7 illustrates modules within the product integration module of FIG. 1.

FIG. 8 illustrates a flowchart of an exemplary method according to principles described here.

FIG. 9 illustrates an exemplary computing environment which may be employed to operate any of the modules disclosed here, including portions and/or combinations of such modules, as well as individual such modules.

Like reference numerals refer to like elements throughout.

### DETAILED DESCRIPTION

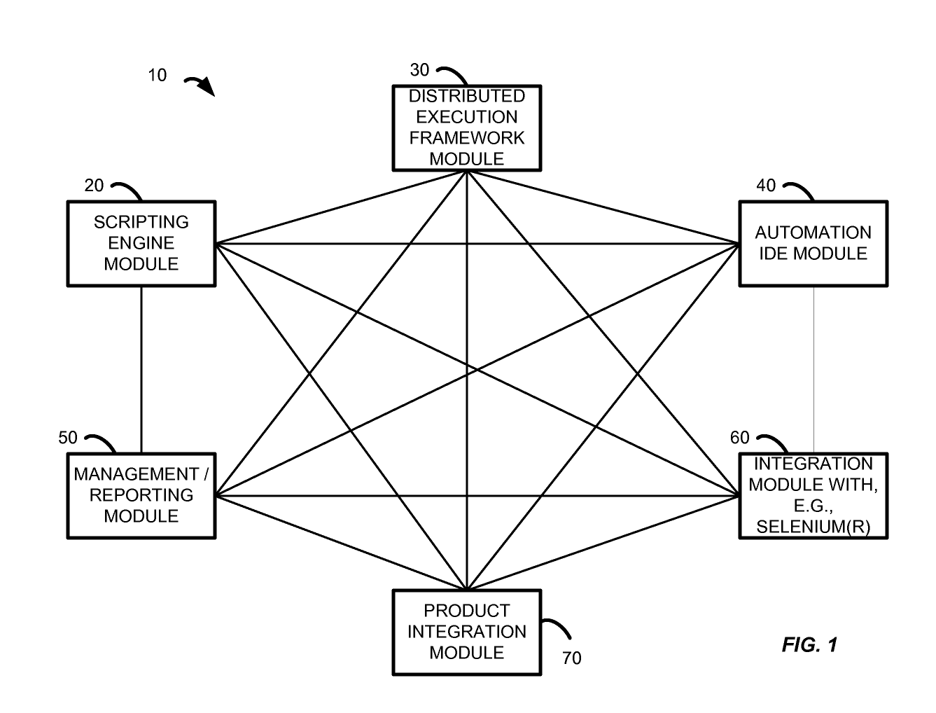

Referring to FIG. 1, a system for automated testing 10 is illustrated with a number of modules 10-70. The modules include a scripting engine module 20, a distributed execution framework 30, an automation IDE module 40, a management/reporting system module 50, a third-party product integration module 60, and a product integration system 70. Not all of these modules are needed in every implementation. Moreover, portions of modules may be hosted within one computing environment, one computing environment may host multiple modules, or a single implementation may include both types. In some cases, a single computing environment may host the modules, which then assigns tasks, also termed here tests or jobs, to one or more other computing environments, such as one or more other computers, in many cases within a “drone farm”, which refers to an assembly of many such network-accessible computers. In general, the scripting engine module 20 provides an interface to an underlying language runtime implementation, i.e., a wrapper that allows tests to be written in a high-level scripting language. The distributed execution framework 30 allows tests to be assigned and spanned across a number of machines. The automation IDE module 40 provides functionality for organizing the tests, e.g., in folders and according to the project they belong to. The management/reporting system 50 provides ways to start, stop, and otherwise schedule tests to be run at particular times. Moreover, the management/reporting system 50 provides ways to check results and review historical data. The integration module 60 provides a way to incorporate third-party products into the system and method. The product integration module 70 provides functionality to integrate the product within a given application, e.g., a complex application such as an MMO. These modules are discussed in greater detail below.

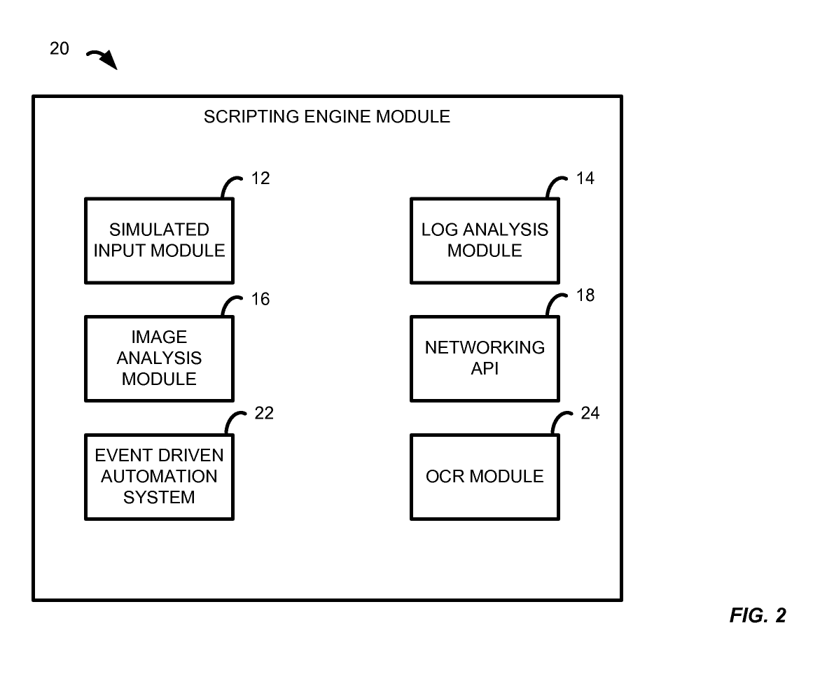

Referring to FIG. 2, a scripting engine module 20 is illustrated with a number of components. In general, the scripting engine module 20 provides an interface to the underlying language runtime implementation. The module allows tests or jobs to be written in a high level scripting language, e.g., JavaScript®, and then compiled and executed in a manner that allows the scripts to access the many underlying systems present in the tool. Besides the scripting itself, the scripting may take advantage of various native function calls accessible by such scripts.

It will be understood that the described components and modules may be generally provided to and implemented on the client systems which will run the tests, with results being reported back to a central controller system, e.g., a server or other computing environment. However, in other implementations, tests may be performed from the controller or server. For example, a step of optical character recognition may be performed from the controller or other computing environment upstream of the client system.

As noted, the scripting engine module 20 further may provide for a number of subsystems which provide features applicable to scripting tasks. In one implementation, a simulated input module 12 is provides that permits functions to access native input buffers of a system, allowing the tool to simulate certain inputs as if a live user had made them. These include, but are not limited to, keyboard inputs in any combination or timing, including, e.g., non-English and Unicode keyboards, mouse movement and button clicks, gamepad and joystick directional and analogue inputs, and button presses.

The scripting engine module 20 may further provide for an image analysis module 16. Using the image analysis module 16, the system may rapidly scan an output such as the display or frame buffer, i.e. to obtain the image that is displayed on a monitor, or other images such as pre-rendered images or bitmaps. In this way, the system can obtain data in real time about what is currently being displayed in an image, and may further allow decisions and tests to be evaluated based upon that information.

As will be described in greater detail below, such image analysis may make full use of system resources by spawning off multiple threads, e.g., by employing multiple cores and multiple machines to analyze parts of an image or to analyze multiple objects or texts from a single image.

The system and method may further provide for an event driven automation system 22. In this way, the scripting engine module 20 not only provides a manner for data to be analyzed, e.g., whether a particular image exist in a particular point in a game, but also provides a means to perform tasks with the result of the data, e.g., using event-driven or scripted logic. In other words, the system and method can perform a step of decision-making about how to handle such data sets, such as spawning actions through the set of provided tools, writing out results, alerting an individual or group through texting or email, or analyzing the same or derivative data. In some implementations, inputs may be aggregated from multiple sources, e.g., image analysis, log analysis (described below), or the like, and employed to make decisions and determine actions.

Using such event-driven automation, not only can tests be performed, but “bots” can be created with significant artificial intelligence that can perform and thus test various in-game tasks. A group of such bots can perform group tasks and (if appropriately configured to match requisite archetypes) may perform group tasks including instances, raiding, and group quests. In a particular example, if the character's health is low, scripted logic may provide that another character “heal” the wounded character. Such concerted testing generally includes cases where multiple code paths contribute to a common goal.

The system and method may further include a log analysis module 14 situated on one or more client machines, the log analysis module 14 being delivered to the client machines initially, before the application or tests are run. The log analysis module 14 provides for real-time log analysis, e.g., tools for parsing that analyze one or more log files, optionally in real-time. The derived data may then be delivered in a manner which is useful and programmatically accessible to the central scripting engine 20, i.e., a script may process and analyze the data without any further independent parsing or redirection. In general, the scripting engine may subscribe to and receive log analysis from remote machines through the network API, described below.

The scripting engine module 20 may further include a networking API 18. In this way, the scripting engine module 20 is integrated with the ability to report, analyze and communicate across a network using a simple messaging API. Through such a system, e.g., a socket system, the system may gather information from other clients running the tool, from the remote log analysis modules described above, e.g., server logs, controllers, e.g., computers that are managing tests, and respond to the same. Such allows for directed and distributed tests that can test multi-user systems that may otherwise take teams of testers and/or users many hours to accomplish.

The scripting engine module 20 may further include an optical character recognition (“OCR”) module 24. The OCR module 24 provides the system and method a capability to detect text displayed on the screen, even in an image format, and test the same against texts that are intended to be displayed. The system and method may provide this ability through an integrated OCR library. In this way, the script engine module 20 receives an image and analyzes the same based upon a set resource font. This parsing may then be translated into a form which may be provided as string data to the script for subsequent analysis.

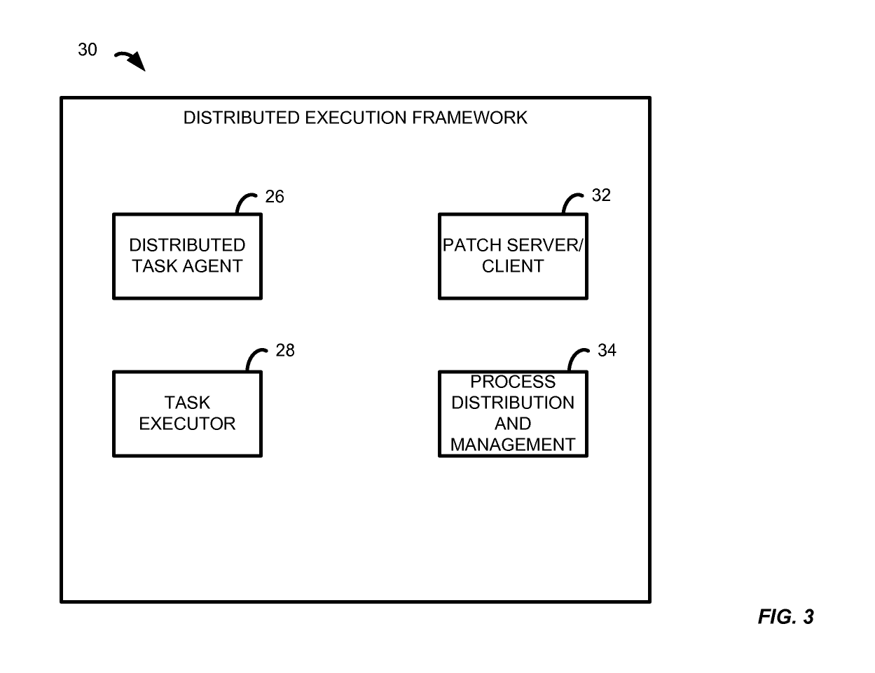

Referring to FIG. 3, the system 10 may further include a distributed execution framework 30. The distributed execution framework 30 includes a number of subsystems, one or more of which may be found in any given implementation.

One such subsystem is a distributed task agent 26, which is implemented by a controller running a controller process. The controller manages the distribution of tests and tasks to client machines, these client machines also termed “drones”. While running a number of tests on one machine may disadvantageously require copious amounts of computing time, when tests are simultaneously spanned across a number of machines, that time may be significantly and advantageously reduced. Systems and methods according to the principles described here have been employed to manage up to one-thousand client systems through an appropriate controller process, while it will be understood that this number is arbitrary and only depends on the capabilities of the controller.

As noted above, each client system is termed a drone and each functions as a task executor 28. In one implementation, each individual drone is capable of running one test at a time, although a multi-core drone may run a test on each core. The task agent 26, e.g., the controller process, assigns each drone a task from a job queue, ensuring that each test is performed before the job is considered complete. The drone completes its task and returns a resulting log to the task agent, which then forwards the log for persistence to a database server.

The distributed execution framework 30 may further include a patch server/client 32. The patch server/client 32 performs a patching step for each client that each drone is expected to run before each job. In some implementations, the job cannot be started before each drone has reported that it is appropriately patched and ready to execute the job. In this way, the drones always execute with the same data and binaries. The patch client generally only distributes binary and text files that exist on the patch server, which are generally updated statically.

The distributed execution framework 30 may further include a module 34 for process distribution and management. In this way, for example, the control process and drone interaction can be utilized to perform tasks unrelated to a particular application. For example, any binary can be executed remotely on the drones and monitored by the task agent. In one such implemented system, such a distributed execution framework has been employed to load test servers by executing an HTTP crawler from multiple different machines, all synchronized by a control process. In general, arbitrary applications or tasks can be tested or deployed in this fashion.

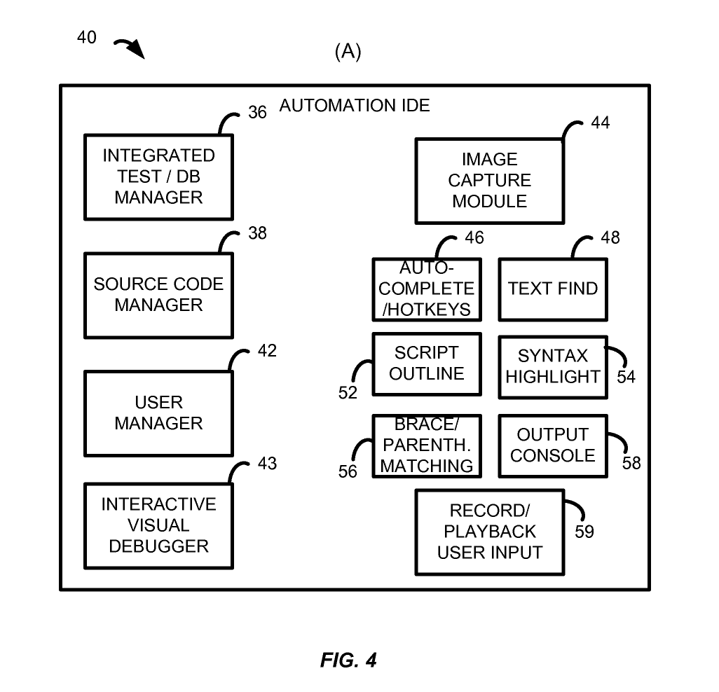

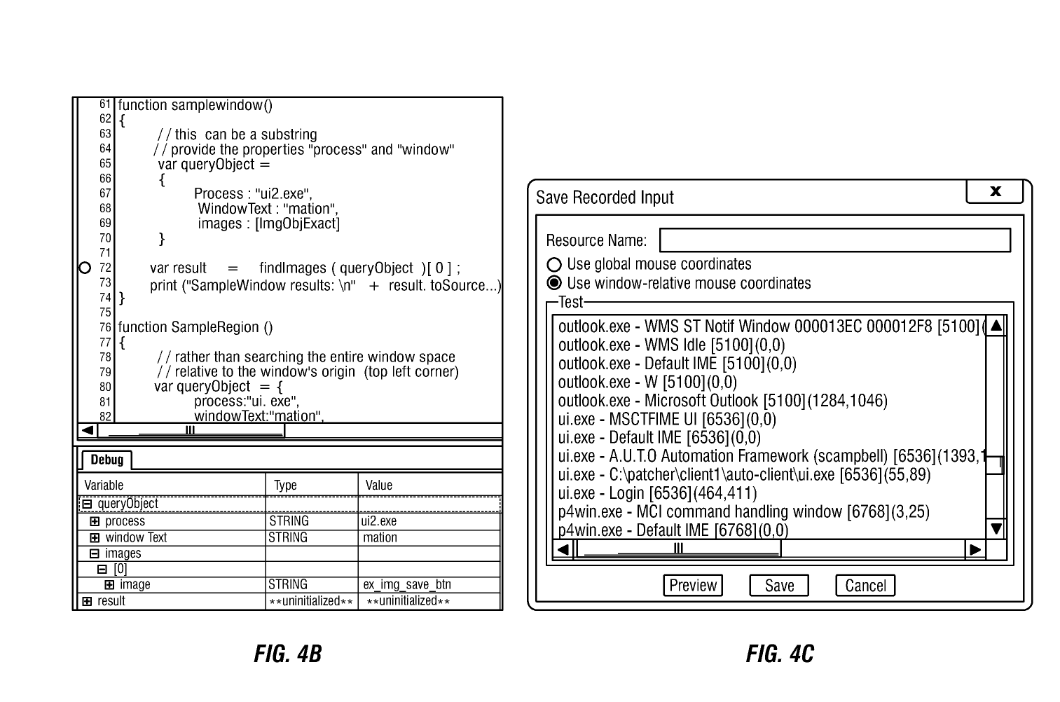

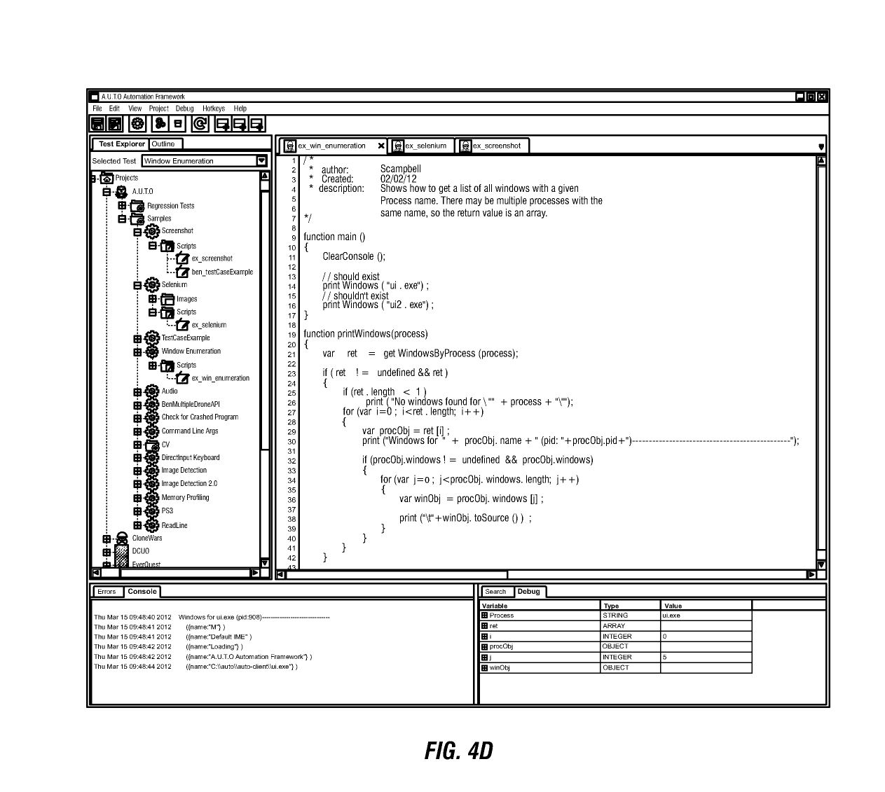

Referring to FIG. 4(A), the system and method may further include an automation integrated development environment (“IDE”) 40. The IDE 40 may include a number of modules, not all of which are required in every implementation. These modules are discussed in greater detail below.

The automation IDE 40 may include an integrated test/database manager 36. Using the manager 36, jobs, tests, tasks, test cases, and the like, may be distributed in a folder hierarchy according to project. The manager 36 may provide the capability for users to create folders, tests, scripts, images, and the like, by utilizing menus of corresponding tree elements in a “Test Explorer” view. The data may be stored in a central database, and accessible to one or more users according to access privileges. In some implementations, all users may access the data.

The automation IDE 40 may further include a source code manager 38. The source code manager 38 provides for protection against data overwrite by a system of locks. In an exemplary implementation, when a first user has a file, e.g., script, locked, no other users may make changes to that file until the first user, or, e.g., another user with proper permissions, unlocks the file. Files may be automatically locked upon commencement of editing. In some implementations, files must be explicitly unlocked upon completion of editing.

The automation IDE 40 may further include a user manager 42. The user manager 42 may be responsible for authenticating users using, e.g., user names and passwords. In one implementation, such a login system may employ Windows Active Directory to perform authentication. User interactions with the systems and methods may be controlled by what permissions are associated with the user. Such permissions may include execute, read, and write, among others.

The automation IDE 40 may further include an image capture module 44. The image capture module 44 may be employed to perform image detection using scripts that reference image resources. Such static images may be captured directly through the IDE 40. Once such images are captured, various tests may be run on the images to verify that the image is that which is intended. The test may include those appropriate to two-dimensional images, as well as those that are appropriate for three-dimensional images. In either case, an appropriate tolerance may be afforded for camera angles, camera distance, and the like.

Various other modules may also be employed to provide convenience and ease-of-use to the automation IDE 40. For example, using an auto complete module 46, functions may be automatically added to user scripts by utilizing auto-complete hotkeys. The user may simply type a partial function name, or use the hotkey alone, to get a list of functions available to the script engine and current script. The text find module 48 may be employed to locate an occurrence of an input text string. The text find module 48 may optionally match whole word, case, or may switch the search direction. Results may be displayed in the search window, grouped first by the script in which they occur, and then delete by line number. Files may be searched, in which case the same may search all imports and scripts which are in a “scripts” folder for the test. A script outline module 52 may provide an outline view. The outline view may provide an alphabetically-sorted overview of the functions defined in a currently-open script. In addition, functions may be defined externally, e.g., through import statements, and the same may also be displayed and organized by script name. Script engine functions, e.g., C++ functions exposed to JavaScript®, may be displayed in a dedicated section as well. In such displays, the function name and parameters may be displayed in a way that is immediately apparent.

The automation IDE 40 may further include a system 54 for syntax highlighting. For example, keywords may be displayed in blue, distinguishing the same from variables. String literals may also be displayed in a unique color. Script engine functions may also appear in blue, so the user may be immediately notified that the same are not defined in a JavaScript® file. Comments may appear in green, indicating that the same will be skipped during execution. It will be understood that any color arrangement may be employed, and that the above is purely exemplary.

Other optional modules include that the automation IDE 40 may have a system 56 for brace/parenthesis matching. Using the system 56, placing a cursor next to a brace or parenthesis may cause the corresponding brace/parenthesis pair to be highlighted. Such is particularly useful when tracking down compilation and syntax errors. If there is no match, the brace/parenthesis may appear in red indicating an error. The automation IDE 40 may further include an output console 58, through which a user may view the results of their work, e.g., development of scripts.

The automation IDE 40 may further include an interactive visual debugger 43. With this module, breakpoints may be set at various lines of code, allowing the developer to step through the path of execution, and to watch the values of variables change over time. Referring to the screenshot of FIG. 4(B), the breakpoint at line 72 was hit, and the state of the local variables is displayed in the debug tab below. If the operator activates the “step over” button, line 72 is executed, and line 73 becomes highlighted. At that point, the variable “result”, at the bottom of the debug tab, would change from “uninitialized” to some value.

A further feature within some implementations of the automation IDE 40 may be a facility 59 for recording and playing back user input, also called “macros”. Such a facility allows the system to record mouse and keyboard input over time. Such recorded input can then be played back later. In one example, using a Windows® program search box, recording may be commenced, and the following steps recorded: click the Windows® start button, type the name of the game, and click enter (the operator may then stop the recording). Once the recording is stopped, the operator may be prompted with a dialog shown in FIG. 4(C) to save the recording as a resource. FIG. 4(D) illustrates a screenshot of one implementation of the IDE 40 with a sample script for reference.

Other such features of the automation IDE 40 will be understood to one of ordinary skill in the art given this teaching.

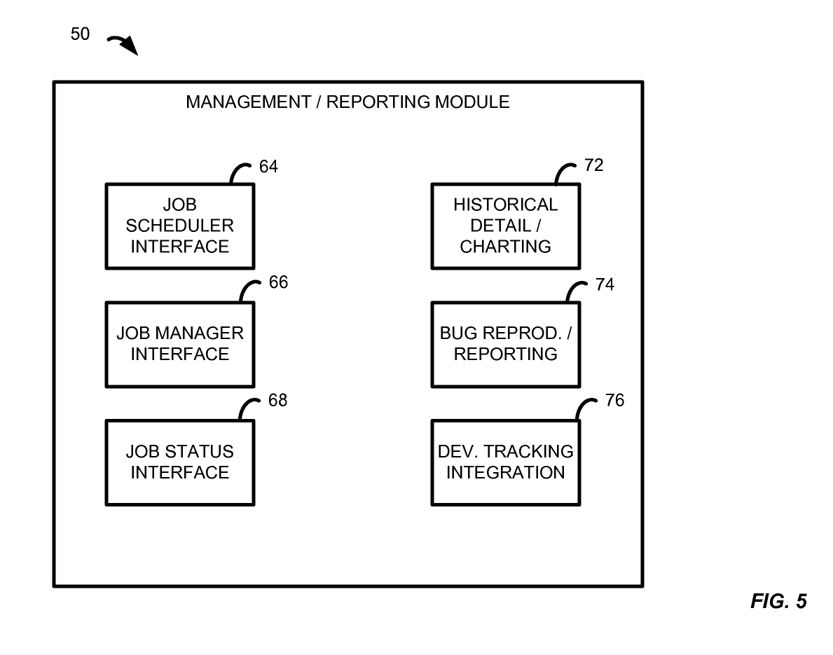

Referring to FIG. 5, and as noted above, the system 10 includes a management/reporting module 50. The management/reporting module 50 includes a number of modules, described below. As will be understood, not all modules are required in every implementation.

The management/reporting module 50 may include a job scheduler interface 64, in which a job, which may include one or more tasks or tests, can be scheduled. All tasks or tests in the job will be executed at the scheduled time provided by the user. In particular, the job scheduler interface 64 allows a user to schedule times in which jobs may be run and repeated, e.g., hourly, daily, weekly, and monthly. Custom schedules may also be provided.

The module 50 further includes a job manager interface 66. From the interface 66, jobs may be paused, started, stopped, and deleted. Further, tasks may be added to a job, and saved as a job template. The user may specify a number of prerequisites per task, allowing for a highly customizable test to be generated from a less-specific test template. Exemplary prerequisites for a drone may include CPU, memory, cores, applications, DirectX® version, and many others. The job manager interface 66 may provide that the task will not be assigned to a drone that does not meet the minimum requirements specification.

The management/reporting module 50 may further include a job status interface 68, which allows a user to view each task individually while jobs are running so that a real-time status can be obtained. For example, users may view the current job, task, and its current state in a clear web interface.

The module 50 may further include other modules and systems, including a system 72 for historical detail/charting. Using the system 72, results of any individual job, and the job specifications, may be maintained arbitrarily, e.g., indefinitely. A detailed bug reproduction/reporting system 74 may be employed that presents to a user, upon a failure, all of the steps the system executes to perform a test. In this way, a manual tester may be enabled to rapidly reproduce a bug, and in this way work to find a solution.

Various systems exist to track development of or bugs within software applications, and a development tracking integration module 76 may be employed to integrate such tracking software with the systems and methods presented here. In this way, issues found during the course of a test execution may be automatically entered into the tracking application and assigned to a specified user during setup. Such a development tracking integration module 76 thus significantly reduces the amount of time between finding an issue to the reporting of the issue, and in particular the subsequent remedy of the issue. Conversely, such systems may be employed to notify the automated testing system of bugs that need review, and may even cause the automatic creation of tests for the same.

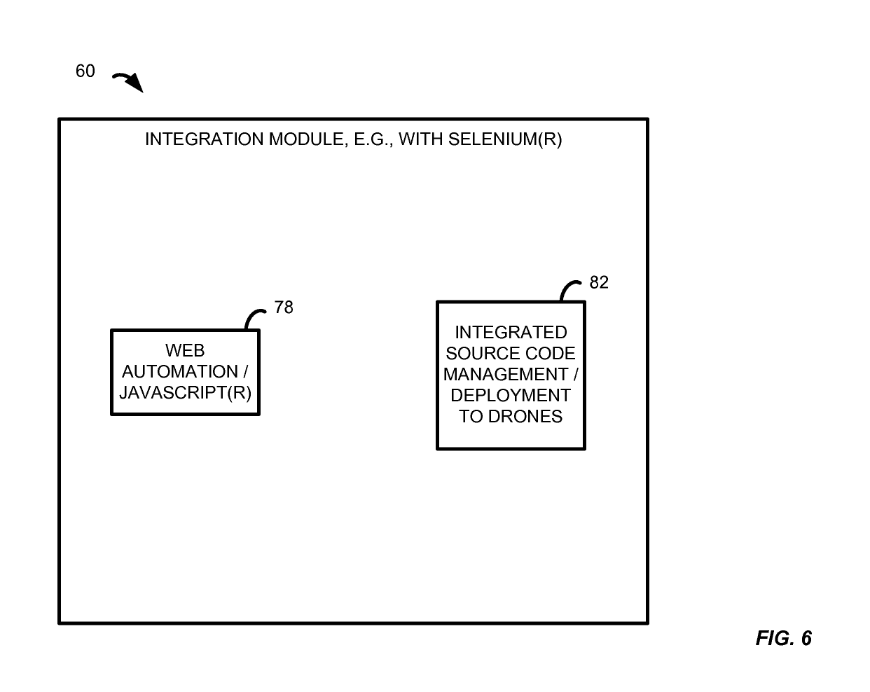

Referring to FIG. 6, an integration module 60 may be provided to allow integration with other third-party applications, e.g., Selenium®. For example, systems and methods according to the principles described here may in some implementations depend on image recognition to accomplish various automation functions. Web displays may be particularly difficult to perform automation within. While it is possible to automate web pages and web-based utilities, it may in some cases be impractical to do so with some tools as images and layouts often change frequently in a web environment. Thus a web-based automation engine such as Selenium® may be employed in combination with an appropriate JavaScript® wrapper to provide the desired functionality using the Web automation/JavaScript® module 78. Such provides significant convenience as users that are familiar with scripting a game-based automation script may be capable of utilizing the IDE 40 to script a web based automation script. This seamless integration allows individual scripters to accommodate a wide spectrum of automation needs. In this regard it is further noted that most any code language may be accommodated, so long as the same can have a JavaScript® binding created for it.

In the particular case of Selenium®, an individual script is generally distributed to each machine before it is capable of being executed. By integrating Selenium® with the system 10, a need for individual distribution is precluded as any client is generally immediately aware of new scripts due to the integrated source code management present in the IDE 40, this routine illustrated in FIG. 6 by module 82.

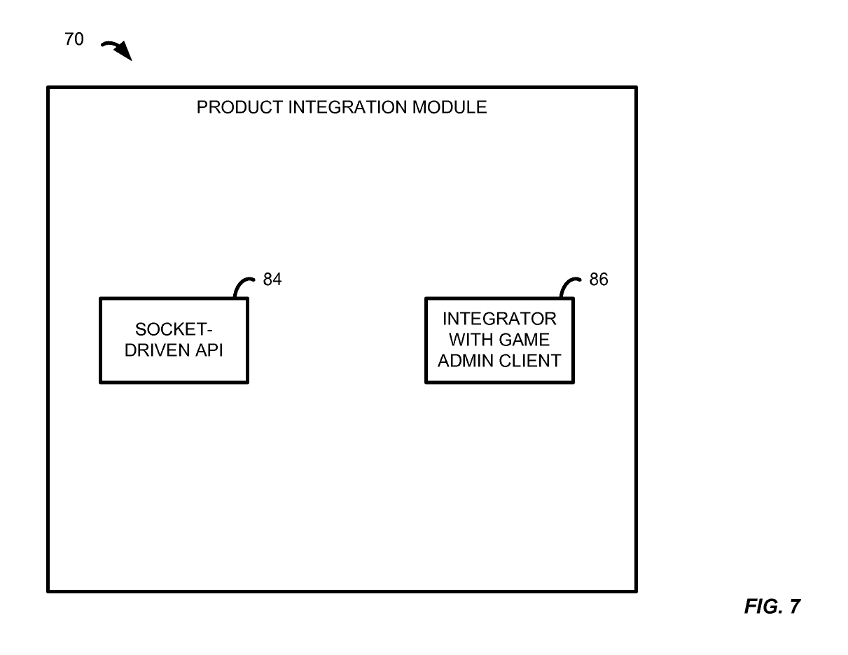

Referring to FIG. 7, a product integration module 70 is illustrated that provides integration to a particular application. The product integration module 70 includes a socket driven API 84 that allows communication with external resources as needed. The product integration module further includes an integrator module 86 which is in data communication with a game administrative client, also termed a “test client”, which refers to an internal build of a given game that generally includes the ability to activate certain features not released to the public. Such then allows the testing of gameplay features of the game in a more timely manner, and a certain amount of customer service for such aspects to occur.

It is noted that besides the above modules a predetermined protocol is generally employed with the set of messages to be passed between the modules in order for the same to interact. The protocol may be known, e.g., XML, TCP, and the like. The protocol need not be specific to a network layer such as a socket, although the same is a convenient means of communication. The system may employ a “hook” or other intermediate mechanism for exchanging data. Such need not be just one way—the game process may itself provide raw data, such as a character's position in the game world, as an output message. Such mechanisms have been employed in the current system in order to pass administrator or tester level commands into a game over a network socket, whereas these would normally have to be inputted via simulated keypresses.

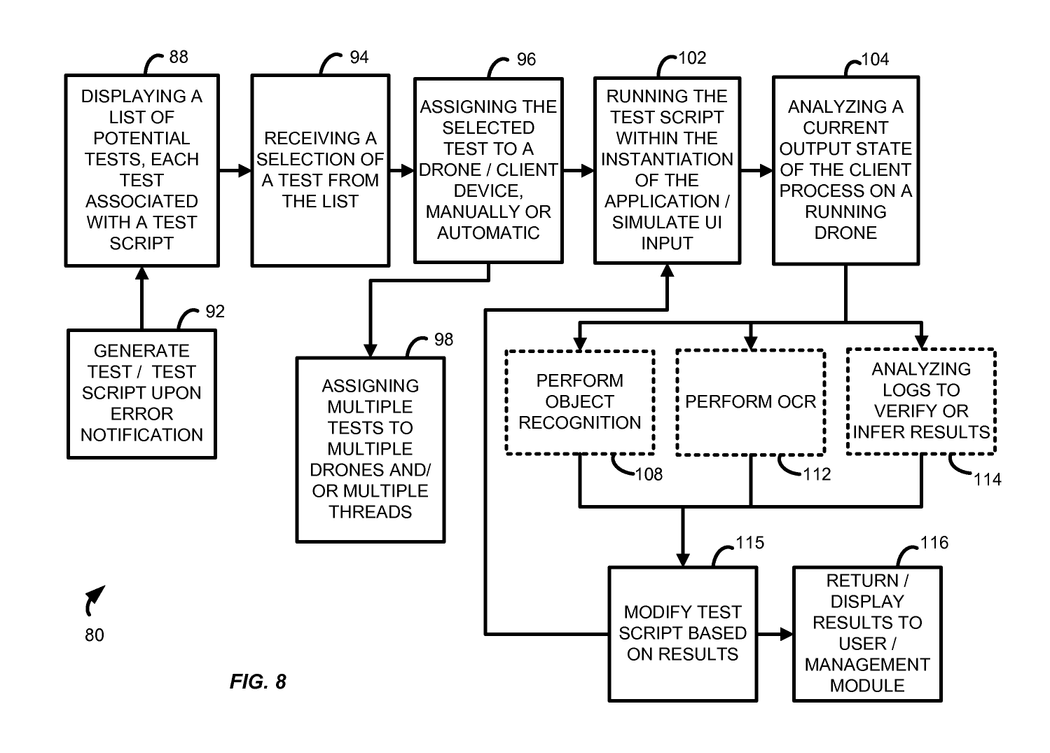

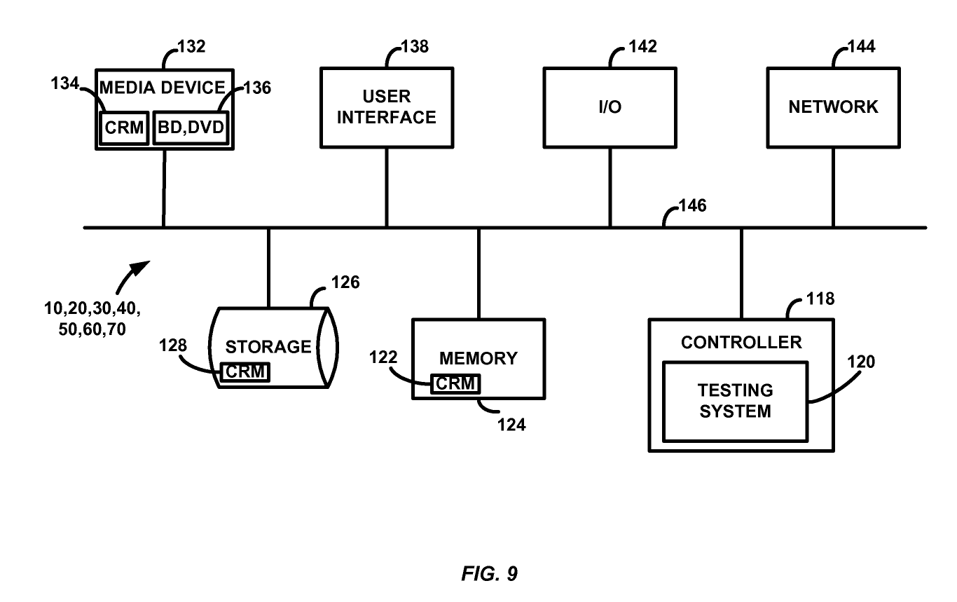

FIG. 8 is an exemplary flowchart 80 illustrating one implementation of a method according to the principles described here. It will be understood that more or less steps may be performed in any given implementation. Steps that are generally optional to any given implementation are illustrated by dotted lines.

A first step is that a list of potential tests is displayed (step 88), each test associated with a test script. Subsequently a selection of a test is received from the list (step 94). It is noted that, rather than a user selecting a test, a user may create a test script for a test using the IDE as noted above. Alternatively, a test and test script may be generated upon an error notification (step 92), such as may occur by log analysis. Moreover, while the flowchart 80 indicates employment of an individual test, it will be understood that the same covers employment of a task or job, where a job is a combination of many tasks or tests.

The selected test is then assigned to a client device, i.e., a drone, either manually or automatically (step 96). For example, the user may desire that a particular test be run on a particular drone, and may direct or assign the test to the drone in this step. Alternatively, the system may see that a particular drone is appropriate for the test, and automatically assign the drone. In yet another alternative, the test may be assigned to a particular core within a client or drone.

The test script is then run within the instantiation of the application (step 102). For example, the test script may be run on a drone which is also operating the application to be tested. The test script generally provides a task to perform, e.g., a button click or review of an image or text. Scripts may include simulated UI input from the keyboard, mouse, game pad, game controller, or the like.

The output state of the client process on the running drone is then analyzed to determine a result of the run test script (step 104). A number of various steps may be employed in this analysis. For example, object recognition may be performed (step 108), in which an object that is expected to appear in the display is tested against those objects actually appearing in the display. In this step, a degree of tolerance may be allowed for three-dimensional objects due to rotation, as well as to account for variations in apparent distance between the camera or viewer and the object. In other words, to account for variations in size due to distance. This step 108 would generally involve analysis of the frame buffer. Another potential step is to perform optical character recognition on text that is detected in a scene (step 112). In other words, for text that appears in an image file, OCR may be performed to convert the image to textual data that can be compared against a database of texts. Such may be particularly appropriate for testing localizations, to ensure foreign-language equivalents are appropriate. This step may also involve analysis of the frame buffer. Another step that may be performed is to analyze logs to verify or infer results (step 114). For example, logs may be analyzed to verify that an image or object appeared at an appropriate time. In another example, logs may be analyzed to infer that a given error occurred, and thus the same may serve as a basis for an automatically-created test. The same may also serve as an input to a software development tracking application, to open a ticket on a particular error and thus begin a solution and testing cycle. Generally, log analysis does not involve analysis of the frame buffer. It is important to note that steps 104, 108, 112, in 114, are generally run as active steps airing the execution of the test script, in that their output often feeds back into the script (step 115).

At completion a final step is to return a result to the user or management module, and, e.g., to display the results of the assigned tests (step 116). The same may be displayed in a number of ways, and generally the results of multiple tests will be displayed, along with an indication of tests run, the drones to which they were assigned, and the like.

It will be understood that the servers described above are generally deemed servers or controllers, depending on context. In the context of game testing, the servers operating the game engine and application are generally game servers, while controllers and control processes may be instantiated on servers or other computing environments. The client devices or drones may be selected from any number of computing environments, including desktops, laptops, tablet computers, handheld computers, smart phones, Internet appliances, game consoles, media PCs, handheld game devices, or the like.

One implementation includes one or more programmable processors and corresponding computing system components to store and execute computer instructions, such as to execute the code that provides the various functional modules disclosed and discussed above. Referring to FIG. 8, a representation of an exemplary computing environment is illustrated, which may represent one or more computing environments operating modules 10, 20, 30, 40, 50, 60, or 70.

The computing environment includes a controller 118, a memory 122, storage 126, a media device 132, a user interface 138, an input/output (I/O) interface 142, and a network interface 144. The components are interconnected by a common bus 146. Alternatively, different connection configurations can be used, such as a star pattern with the controller at the center.

The controller 118 includes a programmable processor and controls the operation of the computing environment and its components. The controller 118 loads instructions from the memory 124 or an embedded controller memory (not shown) and executes these instructions to control the testing system 120.

Memory 124, which may include non-transitory computer-readable memory 122, stores data temporarily for use by the other components of the system. In one implementation, the memory 124 is implemented as DRAM. In other implementations, the memory 124 also includes long-term or permanent memory, such as flash memory and/or ROM.

Storage 126, which may include non-transitory computer-readable memory 128, stores data temporarily or long-term for use by other components of the computing environment, such as for storing data used by the system. In one implementation, the storage 126 is a hard disc drive or a solid state drive.

The media device 132, which may include non-transitory computer-readable memory 134, receives removable media and reads and/or writes data to the inserted media. In one implementation, the media device 132 is an optical disc drive or disc burner, e.g., a writable Blu-ray® disc drive 136.

The user interface 138 includes components for accepting user input, e.g., the user indications of test scripts, jobs, drones on which to run jobs, frequency of testing, job schedules, and the like. In one implementation, the user interface 138 includes a keyboard, a mouse, audio speakers, and a display. The controller 118 uses input from the user to adjust the operation of the computing environment.

The I/O interface 142 includes one or more I/O ports to connect to corresponding I/O devices, such as external storage or supplemental devices, e.g., a printer or a PDA. In one implementation, the ports of the I/O interface 142 include ports such as: USB ports, PCMCIA ports, serial ports, and/or parallel ports. In another implementation, the I/O interface 142 includes a wireless interface for wireless communication with external devices. These I/O interfaces may be employed to connect to the one or more drones.

The network interface 144 allows connections with the local network and includes a wired and/or wireless network connection, such as an RJ-45 or Ethernet connection or WiFi interface (802.11). Numerous other types of network connections will be understood to be possible, including WiMax, 3G or 4G, 802.15 protocols, 802.16 protocols, satellite, Bluetooth®, or the like. Such network connections may also be employed to connect to the drones.

The computing environment may include additional hardware and software typical of such devices, e.g., power and operating systems, though these components are not specifically shown in the figure for simplicity. In other implementations, different configurations of the devices can be used, e.g., different bus or storage configurations or a multi-processor configuration.

Systems and methods according to the principles described here provide a way for convenient and comprehensive testing of large complex applications. In this way, manual testers may be enabled to focus on finding new bugs or errors with applications, and not just of verifying expected functionality as can be efficiently modeled with testing scripts. It is noted, however, that the above description has been exemplary in nature only, and that one of ordinary skill in the art, given the above teaching, will understand that variations are possible that are within the scope of the invention. For example, rather than testing game applications, any number of other such applications may be tested. Moreover, tests may not be limited to just applications. Rather, tests may be configured to test hardware, such as by testing server loads or the like. One task may be made to run on multiple machines, for statistical analysis, as well as to test performance of the task in varying computing environments. Alternatively, different portions of a task may be run on different machines. In addition, with appropriate audio buffering and audio recognition software, not just visual aspects but also audio aspects of an application can be tested.

While PC-type computing environments have been described, console applications may be tested automatically as well. For example, a personal computer may be employed to create inputs as may be simulated for a console game pad. Such may be communicated in a wireless fashion, e.g., by Bluetooth®, in a wired fashion, or in another way. The console display may be directed to a PC monitor, and the resulting frame buffer may be employed to test the results of actions instigated by the simulated input.

Accordingly, the present invention is not limited to only those implementations described above.

1. A method of testing at least a portion of an application, an instantiation of the application running on each of a plurality of computing devices, comprising:
a. displaying a list of potential tests, each test associated with a test script;
b. receiving a selection of a test from the list;
c. assigning the selected test to one of the plurality of computing devices;
d. running the test script on one of the plurality within the instantiation of the application; and
e. analyzing an output of the one of the plurality to determine a result of the run test script.

2. The method of claim 1, wherein the assigning the selected test includes receiving an input indicating the one of the plurality on which to run the test script.

3. The method of claim 1, wherein the analyzing an output includes analyzing a frame buffer.

4. The method of claim 1, wherein the analyzing an output includes analyzing a memory state or examining a network packet.

5. The method of claim 1, wherein the assigning the selected test includes determining a one of the plurality on which to run the test script, the determining including determining a one of the plurality which is capable of running the test script and which is currently not running another test script.

6. The method of claim 1, wherein the receiving and assigning include receiving a selection of a first test and assigning the selected first test to a first one of the plurality, and further comprising receiving a selection of the second test from the list, and assigning the selected second test to the one of the plurality or to another of the plurality.

7. The method of claim 1, wherein the receiving and assigning include receiving a selection of a first test and assigning the selected first test to a first thread on the one of the plurality, and further comprising receiving a selection of the second test from the list, and assigning the selected second test to a second thread on the one of the plurality.

8. The method of claim 1, further comprising analyzing a log to determine at least one operating parameter pertaining to the result.

9. The method of claim 1, wherein the result is a null result.

10. The method of claim 1, wherein the result is an error message.

11. The method of claim 1, further comprising displaying an indication of the result.

12. The method of claim 3, wherein the test script causes a step of optical character recognition of a displayed text within the frame buffer.

13. The method of claim 3, wherein the test script causes a step of object recognition of an object within the frame buffer.

14. The method of claim 1, wherein the test script causes a step of simulating input from a mouse, keyboard, or game pad.

15. The method of claim 1, further comprising generating a test script upon receipt of an error notification from a software development tracking application.

16. The method of claim 6, further comprising displaying a combined result corresponding to the analyzed output and the analyzed log.

17. The method of claim 1, further comprising selecting another test from the list, the another test selected based on the result, assigning the another test to the one of the plurality, running a test script associated with the another test on the one of the plurality within the instantiation of the application, and analyzing an output of the one of the plurality to determine a result of the run test script associated with the another test.

18. The method of claim 17, wherein the test and the another test simulates actions of a bot.

19. The method of claim 18, wherein actions of a plurality of such bots are simulated.

20. The method of claim 19, wherein the simulated bots are configured to accomplish a singular group goal.

21. The method of claim 1, wherein the test is associated with the job, and wherein the job includes a plurality of tests.

22. A non-transitory computer-readable medium, comprising instructions for causing a computing device to perform the method of claim 1.
